(19) United States
(12) Patent Application Publication
(10) Pub. No.: US 2013/0180084 A1
(43) Pub. Date: Jul. 18, 2013

(54) GRIPPING DEVICE FOR HANDLES

(71) Applicant: GREG EDSON, CHICAGO, IL (US)

(72) Inventor: GREG EDSON, CHICAGO, IL (US)

(73) Assignee: Mr. GREG EDSON, CHICAGO, IL (US)

(21) Appl. No.: 13/741,872

(22) Filed: Jan. 15, 2013

Related U.S. Application Data
(60) Provisional application No. 61/587,031, filed on Jan. 16, 2012.

(51) Int. Cl. A45B 9/02; B25G 1/10

(52) U.S. Cl. CPC A45B 9/02; B25G 1/102
USPC 16/430

(57) ABSTRACT

A gripping device for distal end of a tool, product or device that is intended to be held and operated with one hand, that permits a user to insert his or her fingers through rigid finger slots lined with a soft material and rest his or her palm on a cushion connected to the tubular assembly into which said tool, product or device is permanently fixed. The tubular assembly has no less than one and no greater than four finger slots and the cushion is affixed to the tubular assembly opposite the finger slots for ergonomic ease and comfort. The soft material lining the finger slots allows for the inner circumference of the rigid finger slots to mold comfortably to the user's fingers. This gripping device is ideally suited for use with umbrellas.

### CROSS REFERENCE TO RELATED APPLICATION

This application claims priority to U.S. provisional patent application Ser. No. 61/587,031 filed Jan. 16, 2012, the entire content of which is incorporated herein by this reference.

### FIELD OF THE INVENTION

This invention relates generally to a gripping device that may be incorporated into or utilized with any product or tool that is generally designed to be held or operated with one hand. This gripping device is ideally utilized as a handle for a standard umbrella, although it may be readily configured as a handle for other single-hand operable devices. The gripping device of the present invention is particularly effective in situations in which the product into which the device is incorporated will regularly impose a strain on the user's hand, for example, where the user is holding an umbrella upright while in inclement weather and the umbrella is being pulled in various directions due to high winds. In this situation, the user will need to grip the umbrella's handle more tightly, which will strain the user's hand and cause hand and arm fatigue or longer-term chronic use injuries, such as carpal tunnel syndrome. The gripping device of this invention will alleviate this strain and fatigue by providing a more natural gripping shape while simultaneously distributing the umbrella's torque forces more evenly across the surfaces and fingers of the user's hand.

Although the gripping device of this invention is ideally suited for an umbrella handle grip, it is easily incorporated into other products and tools that may require the user to tightly grip the product or tool, thus imposing similar strains on the user's hand and arm. This gripping device can be utilized with hand tools, such as snow brooms, snow brushes, garden tools, such as lawn edgers and trimmers, power tools such as hand-saws or drills, and kitchen implements such as pots, pans, whisks or hand-mixers. Virtually every product or tool that is designed or intended to be operated with one hand will ultimately cause strain on the hand and arm of the users of those products or tools or devices, and the gripping device of the present invention can be incorporated into those products or tools to alleviate that strain.

The gripping device of the present invention accomplishes this by providing an ergonomic, padded surface for the user's hand and a plurality of shaped holes through which the user's fingers are inserted while utilizing the product or tool. Hand products or tools generally require the user to grip a generally hard-surfaced cylindrical handle. The handle for the tool or product is generally given little consideration by its manufacturer, as the operability or functionality of the product or tool will be of primary importance. Yet that operability or functionality will suffer if the user is unable to continue operating or using the product or tool if the user experiences pain or fatigue in his or her arm or hand. The present invention addresses this shortcoming by providing an ergonomic gripping device that forms a more natural gripping surface while distributing forces more evenly through the user's hand and arm.

### BACKGROUND OF THE INVENTION AND PRIOR ART

The present invention is a gripping device for attachment to a product or tool that is intended to be held and operated in one hand. It is particularly suited to be used as a handle for an umbrella. This invention allows an umbrella to be held and operated with decreased gripping strength from the user's hand. The form-fitted finger and hand supports provided with this invention also allow the user to maintain the umbrella in a stable and upright position without an overly tight grip upon the handle.

Many previous attempts have been made to develop a gripping device for hand tools and other implements, such as umbrellas, that are designed to be operated or held in one hand. For example, Ameduri in US Patent Application Publication No. 2010/0287736 A1, describes a tubular gripping handle with an adjustable finger retention strap. The device in Ameduri, however, does little more than secure the user's fingers against a handle. It does not facilitate an ergonomic grip nor does it allow for reduced hand or arm fatigue, as it still requires the user to grasp the handle somewhat tightly. The primary benefit of Ameduri's device appears to be that it secures the tool or product into which the handle is incorporated, such that the user will not drop the tool or product.

Richard, in U.S. Pat. No. 4,977,621 addresses the ergonomics of the gripping surface of the handle that can be used for an umbrella, specifically by providing finger holes that are lined with soft materials like silicone, neoprene, or soft fabric. Richard '621's device is designed to be worn by a user separately and apart from any tool or product and it is not intended to be incorporated directly into the product. Thus, Richard '621 is cognizant of the ergonomic issues involved in gripping hand tools and products and the hand and arm fatigue which can accompany the gripping action, but Richard has not solved the issue of incorporating his device directly into a tool or product.

Richard advances his earlier concept in US Patent Application Publication No. 2009/0313737 A1, which describes a dampening device which cushions the user's hand when a tool or product is gripped. Richard '737 focuses on the use of this device with a baseball bat. Baseball players are well aware that unless a ball is hit with the “sweet spot” of a bat, the impact and vibrations from the impact will communicate an impulse shock to the batsman's hand when a ball is struck with the swung bat. Richard '737's dampening device is intended to lessen or eliminate that shock. While this concept is transferrable to other tools and products, such as umbrellas, again it solves only one issue, namely, reducing or eliminating the shock from forces that are translated into a user's hand or arm when a tool or product is held or operated with one hand.

Brown in U.S. Pat. No. 5,445,582 addresses hand and arm fatigue not by reducing the forces on a user's hand and arm, but by attempting to strengthen the hand and arm with a device that wraps around a user's wrist and encompasses his or her hand with a grip that includes a plurality of finger holes. Although Brown describes a hand grip that includes finger holes lined with soft or pliable materials, Brown's device focuses more on the feature that wraps around the user's wrist to the exclusion of the hand grip. Thus, it would not be apparent from Brown's description of his device to construct a free-standing hand grip that may be integrated directly into a variety of hand tools or products, and particularly into an umbrella.

Prior art references that address gripping devices or that describe tools for gripping other products are rife with descriptions of grips that include finger holes. For example, Garcia in U.S. Pat. No. 6,968,644 describes a clamping tool for gripping fish, which tool includes finger holes for the user's fingers and thumb. Garcia specifically explains that the advantage of using finger holes is to eliminate the possibility of the tool falling out of the user's hands. Garcia also states that the tool may be maneuvered using only the operator's fingers, from which it can be inferred that the user will not stress his or her hand or arm by tightly squeezing the clamping tool. Yet the shape of Garcia's device is specific to the tool itself and the specific grip that Garcia describes is not transferrable to other tools, and again particularly not to an umbrella.

Other prior art references address pieces of a unified grip, but none include all of the elements that are desirable to make a hand tool easy to hold and operate while allowing the user to securely hold the tool in one hand. For example, Balfour in U.S. Pat. No. 4,226,418 describes a tubular, contoured grip for a game racket, which grip includes finger holes and recesses for a user's thumb and palm; Hernandez in U.S. Pat. No. 7,070,169 discusses an ergonomically-shaped grip on a cable puller, which grip directs the position of a user's hands on the actuating lever of the puller; Shulein in U.S. Pat. No. 5,799,369 claims an ergonomic tool handle with a defined surface hardness and thumb and finger rests; LeRoux in U.S. Pat. No. 6,883,207 describes an ergonomic handle to grasp a bag; Marinello in U.S. Pat. No. 7,572,210 discusses a device to train a user to grip a ball properly, which device includes two or more finger holes; and Provenzano et al. describe a hand protection device that cushions a weight-lifter's hands, thus eliminating strain, fatigue or injury. Persons skilled in the arts may well attempt to combine pieces of each of these prior art references to develop a universal grip that may be adapted to a hand tool or product, like an umbrella, but the totality of those pieces would still be lacking the full combination of features that would allow a user to securely hold and operate a hand tool or product while reducing or eliminating fatigue or stress on a user's hand and arm. The resulting product from the combination of these references would be too bulky or cumbersome, or it would add additional stress to the user's hand and arm.

Thus a need exists for a universal gripping device that can be incorporated or manufactured into tools and products that are intended to be operated by a single hand, such as an umbrella, wherein the gripping device is ergonomically-designed and allows the user to maintain control and operation of the tool or product without dropping or losing it.

A need further exists for a gripping device that reduces or eliminates arm and hand fatigue or stress that is a common result of using and operating single-hand tools and products.

Yet an additional need exists for a gripping device that is simple, minimalist in design and not bulky, and lightweight without sacrificing any functions of the hand tool or product on which it is used, or any ergonomic benefits of the device.

The gripping device of the present invention addresses these and other needs. Each of the embodiments of this invention described in this specification, as well as other technical aspects of the present invention and the technical, scientific and other terminology in the present specification are utilized according to their common meanings within the applicable industries and arts, and as known and used by persons skilled in the arts described herein. Nothing in the specification for this invention should be interpreted as a limitation on the present invention. Rather, this specification describes one or more preferred embodiments of the invention as illustrations of the principal aspects of the invention. Persons skilled in the arts described herein will understand the full breadth and scope of this invention, including its many permutations and practical embodiments.

### BRIEF DESCRIPTION OF THE DRAWINGS

The drawings which accompany the description of this invention are provided for information and descriptive purposes only. Any particular features and details included in the drawings are included solely as an aid to describe one or more of the best methods of utilizing the device and practicing the method of the present invention. The details provided in the drawings are not included as limiting factors, and are included only to the extent that such details are deemed to be necessary to describe certain fundamental aspects of the device and method of the present invention. Persons skilled in the arts to which this invention refers will understand that other forms and embodiments of this invention are available, and such persons will know and understand how to create and implement those other embodiments.

In the drawings:

FIG. 1 is a side view of a gripping device of the present invention;

FIG. 2 is a perspective view of a gripping device of the present invention;

### DETAILED DESCRIPTION OF THE INVENTION

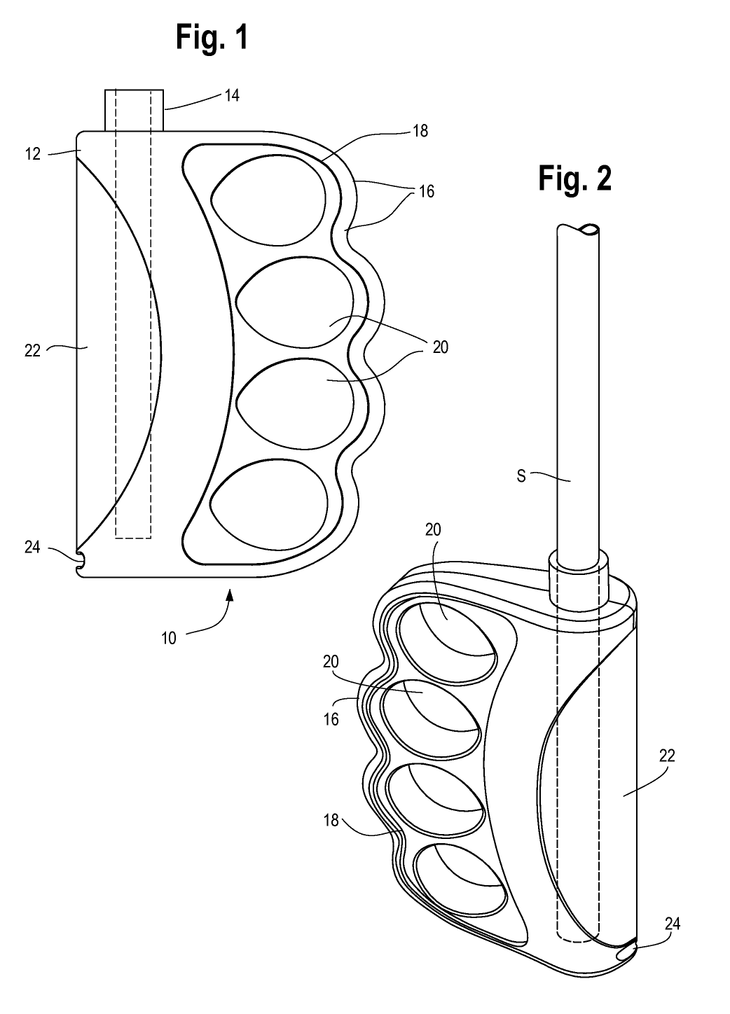

Referring now to the present invention in more details, in FIG. 1 there is shown the present invention generally referred to with numeral 10. The gripping device of the present invention consists of a generally tubular assembly 12 that has a central shaft 14 into which the distal end of hand tool or other device that is intended to be operated and used with one hand will be permanently and firmly inserted. The device 10 in FIG. 1 is particularly configured such that an umbrella stem may be permanently and firmly inserted into central shaft 14. The generally tubular assembly 12 can be composed of any rigid material, including but not limited to ABS plastic or polycarbonate.

Extending perpendicularly from the central shaft 14 is the rigid grip portion 16 that defines the finger slot space 18. Lining the inner portion of the finger slot space 18 is a soft material creating lined finger slots 20. This same soft material is also used to form a cushion 22 for the palm on the tubular assembly 12 opposite the finger slot space 18. This is best seen in FIG. 1. The embodiment of the gripping device depicted in FIGS. 1 and 2 includes four finger slots 20. Alternate embodiments of this invention may include one, two or three finger slots 20, and it is not the intention of the inventor to limit this invention to include four finger slots. Further, in another alternate embodiment of this invention, the soft material that lines finger slots 20 may be removable and replaceable. This may be preferred where, for example, it is anticipated that the material will lose its resiliency and softness over a period of time, or where the material becomes soiled or torn.

The embodiment of the present invention shown in FIGS. 1 and 2 is specifically configured such that the tubular assembly 12 has cooperative dimensions to snuggly receive the distal end of an umbrella stem S, as seen in FIG. 2. Persons skilled in the relevant arts will understand that tubular assembly 12 may be adaptably manufactured to receive the distal ends of a broad range of products and hand tools, and it is not the intention of the present invention and specification to limit itself to use solely as a gripping device for umbrellas.

The embodiment of the present invention depicted in FIGS. 1 and 2, which is configured to be used as a gripping device for an umbrella, also illustrates customizations that may be included with the gripping device. For example, this embodiment contemplates the use of this gripping device for either a manual umbrella or an automatic umbrella with a push-button. Persons skilled in the relevant arts will readily understand how to incorporate push-button opening and closure mechanisms into this gripping device without affecting its form or function or derogating from the ergonomics of the gripping device.

In the embodiment depicted in FIGS. 1 and 2, assembly 12 can be made of plastic, polyurethane or equivalent rigid material allowing the assembly 12 and finger slot space 18 to retain their shapes. Also in this embodiment, four finger slots 20 are shown. The finger slots 20 extend from the tubular assembly 12 at a predetermined distance along the tubular assembly 12 and are positioned at a cooperative spaced-apart distance to permit a user's fingers to comfortably insert into the finger slots 20, as shown in the drawings for this embodiment. The finger slots 20 are also shown to be aligned along a curvilinear arc, which more comfortably and ergonomically matches the natural closure positioning of a user's hand. The radius of this arc will be determined by the manufacturer to conform to general hand sizes of anticipated users.

The finger slots 20 define rounded shapes, such as circles, ovals, or oblong shapes. The finger slots 20 leave room for the user's fingers to fit snuggly but comfortably into their internal diameters. The finger slots 20 will be preferably lined with a soft comfortable material in order to accommodate various finger diameters of a user in a manner that minimizes or eliminates chafing or rubbing. Use of other pliable materials capable of maintaining the shapes of the finger slots 20 is also contemplated, including but not limited to firm rubber, silicon, polyurethane, silica gel and memory foam. When the gripping device of the present invention is incorporated into an umbrella, it is anticipated that forces from wind will translate down a shaft S and into the gripping device, and the user will experience those forces through pressure exerted against his or her fingers when inserted into finger slots 20. An excess of material will substantially dampen the forces that are translated into a user's hand, but that excess will also make it difficult for a user to insert and remove his or her fingers from finger slots 20. Conversely, a minimal amount of material will ease the insertion and removal of a user's fingers, but will be insufficient to dampen translated forces. The manufacturer will thus need to determine the optimum type and amount of pliable material with which to line the finger slots 20.

The cushion 22 for the user's palm is located on the tubular assembly 12 opposite the finger slots 20. The cushion 22 is constructed of the same soft material as the foam liners used to line the finger slots 20. The cushion 22 may be substantially the length of, or the entire length of, the tubular assembly 12, and the width of the cushion 22 may be between two inches and four inches to substantially accommodate the palm of a user's hand. As with the material that is used to line the finger slots 20, in an alternate embodiment of this invention, the cushion 22 may be removable and replaceable as it becomes worn, soiled or torn. An indentation 24 is also depicted in FIGS. 1 and 2 as being located on the tubular assembly 12 opposite the finger slots 20 and below the cushion 22 into which a string or strap may be inserted for ease of carrying and storing the combined gripping device and umbrella.

As shown in FIGS. 1 and 2, rigid grip portion 16 extends along the entire length of the gripping device. The natural length of the gripping device is that which generally matches the width of a user's hand, and again this length will be determined by the manufacturer to conform to general hand sizes of anticipated users. FIGS. 1 and 2 generally depict one manufacturing option for the present invention, namely that tubular assembly 12 and grip portion 16 may be molded out of a continuous piece of material, with finger slots 20 and cushion 22 being inserted into that continuous piece of material. Alternately, tubular assembly 12 and grip portion 16 may be manufactured as matching minor-image halves, thus facilitating easier incorporation and attachment of shaft S into the gripping device. When the gripping device of this invention is configured to work with an automatic umbrella, or with any other hand tool or product that may require an on-off switch or operational button, it may be preferable to utilize this matching mirror-image manufacturing option to better facilitate incorporation of the automatic operating mechanism.

FIG. 2 shows the cushion 22 covering the entire width and substantially the entire length of the depicted side of the gripping device. The actual dimensions of the cushion 22 will be determined as a function of the ergonomics and general gripping comfort that is desired for the gripping device.

The tubular nature of the assembly of the gripping device is more clearly depicted in FIG. 2, which shows the top end of the gripping device as having an opening to receive an umbrella shaft or other shaft of a product or hand tool that will be combined with this gripping device. FIGS. 1 and 2 show slot 24, which is intended to accept a cord or other structure to hang or store the combined gripping device and tool or product, as being included on a side of the gripping device. An alternate embodiment of this feature would incorporate slot 24 into the solid bottom of the gripping device depicted in FIG. 6.

The advantages of the present invention include, without limitation, vastly improved ergonomics above the current umbrella constructions. The finger slots 20 created from foam or foam-like material as well as the cushion 22 provide stability of the attached umbrella for the user, as well as providing the user with increased grip on the umbrella particularly during wet and/or windy conditions. The finger slots 20 prevent any sliding movement of a user's hand along the tubular assembly 12. Additional advantages exist particularly for users having carpal tunnel syndrome or other degenerative or arthritic conditions causing the user to have a decreased strength in the muscles and/or joints of the hand or a decreased ability to exert a forceful grip on a handle. The foam construction of the finger slots 20 and cushion 22 provide an increased and superior level of comfort for such users, allowing the umbrella to remain stable and firmly in the user's hand without need for the hand strength normally required to maintain an umbrella's position, particularly in wet or windy conditions.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples used herein. The invention should therefore not be limited by the above described embodiment, method, and examples, but by all embodiments and methods within the scope and spirit of the invention

What is claimed is:

1. A gripping device, comprising an elongated tubular assembly having a substantially cylindrical cross-section, said tubular assembly including first and second ends and a palm surface, said second end being closed and said first end having cooperative dimensions to receive the shaft of a hand tool, further including a finger slot space opposite said palm surface on the tubular assembly.

2. The gripping device set forth in claim 1 wherein said finger slot space is lined with a soft material, said soft material creating at least one space through which a finger or fingers may be inserted.

3. The gripping device set forth in claim 1 wherein said palm surface contains a cushion padded with said soft material.

4. The gripping device set forth in claim 1 including said finger slot space lined with a soft material and said palm surface contains a cushion padded with said soft material.

5. The gripping device set forth in claim 1 wherein said gripping device is configured to be utilized with a folding umbrella, said umbrella being configured to open and close manually.

6. The gripping device set forth in claim 1 wherein said gripping device is configured to be utilized with a folding umbrella, said umbrella being configured to open and close automatically via automatic opening and closing means that are incorporated into said gripping device.

7. The gripping device set forth in claim 1 wherein said gripping device is further configured to include operating means for a hand tool into which said gripping device is incorporated.

8. The gripping device set forth in claim 1 wherein said gripping device is manufactured out of a single piece of rigid material.

9. The gripping device set forth in claim 1 wherein said gripping device is manufactured out of two mirror-image matching pieces of material.

10. The gripping device set forth in claim 1, further including means to accept a strap.

11. The device set forth in claim 2 wherein said tubular assembly includes two finger slots.

12. The device set forth in claim 2 wherein said tubular assembly includes three finger slots.

13. The device set forth in claim 2 wherein said tubular assembly includes four finger slots.

14. The device set forth in claim 2 wherein said soft material that lines said finger slot space is removable and replaceable.

15. The device set forth in claim 3 wherein said cushion that lines said palm surface is removable and replaceable.
